(19) United States
(12) Patent Application Publication
(10) Pub. No.: US 2004/0154676 A1
(43) Pub. Date: Aug. 12, 2004

(54) ABRASION-RESISTANT HOSE

(75) Inventor: Daniel M. Wilkinson, Cadillac, MI (US)

Correspondence Address: MCGARRY BAIR PC, 171 MONROE AVENUE, N.W., SUITE 600, GRAND RAPIDS, MI, 49503, US

(73) Assignee: PIRANHA HOSE PRODUCTS, INC., Cadillac, MI (US)

(21) Appl. No.: 10/707,925

(22) Filed: Jan. 26, 2004

Related U.S. Application Data
(60) Provisional application No. 60/319,926, filed on Feb. 6, 2003.

(51) Int. Cl. F16L 11/00

(52) U.S. Cl. 138/125; 138/123; 138/137

(57) ABSTRACT

A hose comprising an inner tube of a synthetic resin, a non-reinforcing, abrasion-resistant layer of monofilament strands overlying the inner tube and, a cover layer overlying the inner tube and encapsulating the abrasion-resistant layer, and, optionally, a reinforcing layer between the inner tube and the abrasion-resistant layer of monofilament strands. The monofilament strands can be arranged in a regular pattern, for example, in a loosely-woven net of the monofilament strands and can have a diameter greater or less than the spacing between the monofilament strands, with the spacing between the monofilament strands ranging from 50-200% of the diameter of the monofilament strands.

### CROSS REFERENCE TO RELATED APPLICATIONS

This application claims the benefit of U.S. provisional application Serial No. 60/319,926, filed Feb. 6, 2003, which is incorporated herein in its entirety.

### BACKGROUND OF INVENTION

1. Field of the Invention

This invention relates generally to abrasion-resistant hoses. In one aspect, the invention relates to a low pressure, abrasion-resistant hose. In another aspect, the invention relates to a high-pressure abrasion-resistant hose. In another aspect, the invention relates to a method of making an abrasion-resistant hose.

2. Description of the Related Art

Air hoses are used to supply pressurized air to work tools from a compressor or other source of pressure. In many cases, these hoses are used in construction sites and on shop floors and are subject to abrasion from the floor, ground or equipment. An abrasive-resistant layer can be coated onto the hoses to increase the abrasion resistance of the hoses. These abrasion-resistant layers are typically very hard and inflexible and tend to decrease the pliability of the hoses. The hoses must remain flexible in order to be portable and easy to use.

U.S. Pat. No. 3,945,867 to Heller, Jr. et al. discloses a hose comprising a hollow core surrounded by a burst-resistant reinforcing net formed of a lattice of strands or yarn, and a coating over the core and the strands. The Heller, Jr. '867 patent also discloses a hose comprising a core surrounded by a bonding layer in which strands of a burst-resistant netting are partially embedded. A coating surrounds the bonding layer and the strands. The bonding layer comprises a separate layer selected for its capacity to bond to the core when heated and to mechanically engage the net.

U.S. Pat. No. 6,302,150 to Martucci et al. discloses a hose comprising a melt extrudable fluorocarbon-based tubular inner layer overlain by a braided, burst-resistant reinforcing layer. The braided material used in the reinforcing layer can comprise a monofilament. The strands comprising the reinforcing layer are tightly braided together. The inner layer is partially melted during fabrication of the hose to bond the burst-resistant reinforcing layer to the inner layer. This process results in the penetration of the inner layer material into gaps between the reinforcing layer filaments to form an integral assembly comprising the reinforcing layer and the inner layer. A cover layer extends over the reinforcing layer.

U.S. Pat. No. 5,381,834 to King discloses a hose comprising a fluorocarbon-based inner liner overlain by a burst-resistant braided layer. Multifilament yarns are used to form the braided layer. The yarn strands comprising the reinforcing layer are relatively tightly braided together. A fluorinated polymer is coated onto and into the braided layer.

U.S. Pat. No. 6,390,141 to Fisher et al. discloses a multilayered hose comprising a multilayered tubular core overlain by a burst-resistant reinforcing layer. An inner elastomeric layer overlays the reinforcing layer. A helical reinforcing element, which may comprise a monofilament, is wound in a spiral pattern over the elastomeric layer. An outer elastomeric layer overlays the inner elastomeric layer and the reinforcing element to completely encapsulate the reinforcing element within a 2-component elastomeric layer. The elastomeric layer forms the outermost jacket for the hose.

The prior art air hoses are susceptible to damage due to abrasion of the outermost layer such as can occur as the hose is dragged over rough surfaces such as pavement. If the abrasion is allowed to continue through the outermost layer, the reinforcing layer can be abraded, thereby shortening the life of the hose, weakening the hose against bursting, and exposing persons and property to injury. Even a small abrasion or cut in the reinforcing layer can weaken the reinforcing layer and raise the potential for failure sufficiently to render the entire hose unusable.

### SUMMARY OF INVENTION

According to the invention, a hose comprises an inner tube of a synthetic resin, a non-reinforcing, abrasion-resistant layer of monofilament strands overlying the inner tube and, a cover layer overlying the inner tube and encapsulating the abrasion-resistant layer, and, optionally, a reinforcing layer between the inner tube and the abrasion-resistant layer of monofilament strands.

The monofilament strands can be arranged in a regular pattern, for example, in a loosely-woven net of the monofilament strands and can have a diameter greater or less than the spacing between the monofilament strands, with the spacing between the monofilament strands ranging from 50-200% of the diameter of the monofilament strands. The monofilament strands that form the abrasion-resistant layer are relatively large in diameter compared to conventional reinforcing fibers. Typically, the diameter of the abrasion-resistant monofilament strands is in the range from about 0.20 to 0.80 inches. The monofilament strands can be made from a variety of synthetic or natural materials. Suitable materials are nylon and polypropylene.

The abrasion-resistant monofilament strands differ significantly from the traditional reinforcing yarns and nets woven therefrom used in conventional reinforced hoses. Generally, the abrasion-resistant strands are much larger in diameter than the yarn used in conventional reinforcing layers and have far less strength than the reinforcing yarn. For example, the bursting strength of the reinforcing layer for a hose used in a typical high-pressure application will generally be in the range of 2500 to 5000 psi, whereas the bursting strength of the abrasion-resistant layer will be in the range of 0 to 200 psi. This reduced bursting strength is due in part to the loose weave of the abrasion-resistant layer and the consequent reduction in interactive strength augmentation between individual monofilament strands.

The inner tube can be made of a variety of synthetic thermoplastic or thermosetting resins, including a semi-rigid thermoplastic material such as polyethylene, polypropylene or nylon, or an elastomeric material.

The hose can optionally include a tie layer between the inner tube and the abrasion-resistant layer to bond the inner tube to the abrasion-resistant layer. The tie layer can be an adhesive-grade nylon if the monofilament strands are nylon, or an adhesive-grade polyolefin if the monofilament strands are polypropylene or and adhesive-grade urethane if the monofilament strands are polyurethane.

The cover layer can be a variety of synthetic thermoplastic or thermosetting resins, for example, an elastomeric material, such as polyurethane, a thermoplastic rubber, conventional rubber, or silicone.

In another embodiment of the invention, a method of making an abrasion-resistant hose comprises the steps of extruding an inner tube, applying to the outer surface of the inner tube a non-reinforcing, abrasion-resistant, loosely woven net of monofilament strands, and at least partially encapsulating the woven net of monofilament strands with a cover layer. The method can further comprise the step of interposing a tie layer between the inner tube and the abrasion-resistant layer to bond the inner tube to the abrasion-resistant layer. The tie layer can be an adhesive-grade nylon when the monofilament strands are nylon, or an adhesive-grade urethane when the monofilament strands are polyurethane.

The method can further comprise the steps of interposing a reinforcing layer between the inner tube and the abrasion-resistant layer, and interposing a tie layer between the reinforcing layer and the abrasion-resistant layer to bond the reinforcing layer to the abrasion-resistant layer.

### BRIEF DESCRIPTION OF DRAWINGS

In the drawings:

FIG. 1 is a perspective cutaway view of a first embodiment of a hose according to the invention.

FIG. 2 is a cross-sectional view of the hose of FIG. 1 taken along line 2-2.

FIG. 3 is a perspective cutaway view of a second embodiment of a hose according to the invention.

FIG. 4 is a schematic representation of a method of making the hose shown in FIG. 1.

### DETAILED DESCRIPTION

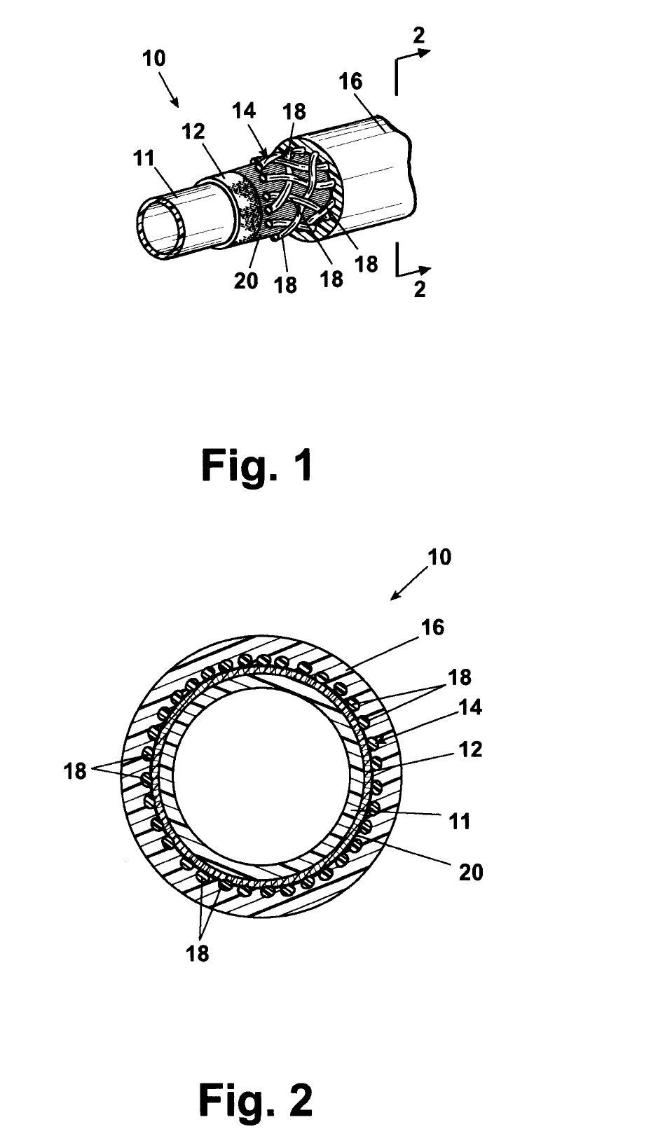

Referring to FIGS. 1 and 2, a first embodiment of a hose 10 according to the invention comprises an inner tube 11, a reinforcing layer 12 overlying the inner tube 11 to provide resistance against bursting, and an outer cover layer 16 encasing the inner tube 11 and the reinforcing layer 12. The inner tube 11 is an annular member comprising a suitable material compatible with the fluid to be transported through the hose 10. In the preferred embodiment, the inner tube 11 comprises a semi-rigid thermoplastic material, such as polyethylene or nylon. Typically, polyethylene is utilized when the hose will carry water or certain aqueous solutions, and nylon is utilized when the hose will carry organic or hydraulic fluids. Polyester tubes can also be utilized for hydraulic fluids. Alternatively, the inner tube 11 can comprise an elastomeric material such as rubber. The flexibility of the inner tube 11 can also be selectively varied from rigid to flexible.

The reinforcing layer 12 preferably comprises a generally conventional sleeve fabricated of multifilament yarn that is adapted to fit tightly around the inner layer 11. The reinforcing layer 12 can be a variety of patterns, including spiral bound, knit, or braided in a manner well-known in the industry suitable for the pressure to be carried by the hose. Suitable materials for the reinforcing layer 12 include polypropylene, aramid strands such as Kevlar®, or nylon. Suitable reinforcing materials include Fortrel® polyester manufactured by KoSa of Houston, Tex., and Nylon 840 manufactured by DuPont.

The cover layer 16 comprises a thermoplastic or thermoset polymer capable of controlled flow within a preselected elevated temperature range. Suitable materials for the cover layer 16 include polyurethane, a thermoplastic rubber, rubber, or silicone. A preferred material is polyurethane. The material selected for the cover layer 16 can also comprise an additive selected to increase the abrasion resistance of the cover layer material.

Imbedded in the cover layer 16 is an abrasion-resistant layer 14 preferably comprising a pattern of monofilament strands 18, preferably a net having an open weave and tightly bound around the underlying reinforcing layer 12. The strands 18 comprise a single untwisted strand of material that has a relatively large diameter compared to the yarn used in the reinforcing layer. For example, the fiber diameter can range from 0.20 to 0.80 inches and the spacing between the strands can range from 50-200% of the diameter of the strands. The open weave of the monofilament strands 14 enables the cover material to flow through the abrasion-resistant layer 14 to the underlying layer during the cover extrusion process to embed the monofilament strands 18 in the cover layer 16 and bond the cover layer 16 to the underlying layer. The monofilament strands 18 comprise a material having a high resistance to abrasion such as nylon, preferably Nylon 6 manufactured by Shakespeare Monofilaments and Specialty Polymers of Columbia, S.C. Other suitable materials for the abrasion-resistant monofilament 18 include polypropylene and polyurethane.

The abrasion-resistant monofilament 18 of the invention differs significantly from the traditional reinforcing yarns and net woven therefrom used in this invention and in conventional reinforced hoses. Generally, the abrasion-resistant strands 18 are much larger in diameter than the yarn used in conventional reinforcing layers and have far less bursting strength than the reinforcing yarn. For example, the bursting strength of the reinforcing layer for a hose used in a typical high-pressure application will generally be in the range of 2500 to 5000 psi, whereas the bursting strength of the abrasion-resistant layer will be in the range of 0 to 200 psi. This reduced bursting strength is due in part to the open weave of the abrasion-resistant layer and the consequent reduction in interactive strength augmentation between individual monofilament strands.

The strength of the fibers used in conventional reinforcing layers is measured in terms of “tenacity”. The units for tenacity are grams/denier. Typical textile reinforcing fibers have a tenacity of about 8 to 10 grams/denier. Arimids or “Kevlar” type materials have a tenacity of about 12 to 16 grams/denier. In contrast, the tenacity of the abrasion-resistand monofilament strands is about 5 grams/denier, which is insufficient for a conventional reinforcing layer.

Further, the spacing between the reinforcing yarns and the abrasion-resistant strands 18 differ greatly. Whereas the reinforcing yarns will typically be tightly woven so that they interact with each other, the abrasion-resistant monofilament strands 18 are typically spaced relatively far apart, can shift somewhat with respect to each other, and do not interact in the same way as the reinforcing yarns to provide bursting strength to the hose. The tight weave of the reinforcing layer contributes significantly to its bursting strength, particularly for medium to high pressure hoses.

Typically, the spacing between the abrasion-resistant monofilaments strands 18 will vary between 50-200% of the diameter of the monofilament, whereas there will be minimal or no spacing between the reinforcing fibers, resulting in a weave in which the fibers are in close contact. When the diameter of the monofilament strands 18 is greater than the space between the strands, the hose has an improved kink resistance. This kink resistance is believed to be due to the tendency of the monofilament strands 18 to roll up on itself when the hose is bent.

In a preferred embodiment of the invention for carrying organic fluids at a pressure of between 2500 and 500 psi, the monofilaments strands 18 can be Nylon 6, manufactured by Shakespeare Monofilaments and Specialty Polymers, for example. The inner tube 11 is nylon, and the reinforcing layer 12 comprises woven Fortrel polyester manufactured by KoSa. The cover layer 16 can be a polyester compound. As shown in FIG. 2, the monofilament strands 18 in the abrasion-resistant layer 14 are in contact with the reinforcing layer 12, with a relatively thick section of the cover layer 16 overlying the abrasion-resistant layer 14. The thickness of the cover layer 16 above the abrasion-resistant layer 14 can vary depending upon the technical fabrication requirements of the particular process used to apply the cover layer 16 over the abrasion-resistant layer 14 so long as the cover layer material fully encapsulates the monofilament strands 18.

A tie layer 20 can optionally be provided between the reinforcing layer 12 and the abrasion-resistant layer 14 to ensure adequate bonding of the nylon monofilaments 18 to the reinforcing layer 12 to prevent slippage between the materials during the fabrication of the hose 10. Suitable materials for the tie layer 20 include adhesive-grade urethane and adhesive-grade nylon.

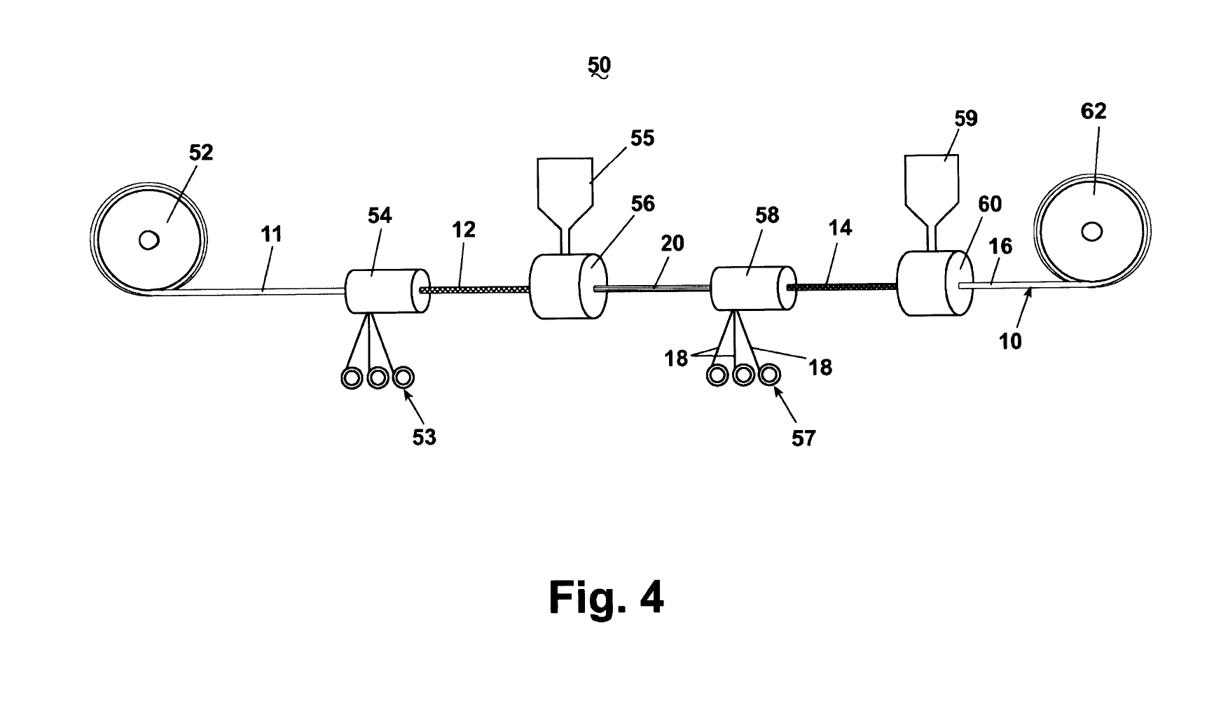

With reference to FIG. 4, the hose 10 is fabricated in a hose fabrication line 50 as follows. The inner tube 11 is unwound from a roll 52 and enters a reinforcing weaving station 54 in which the reinforcing layer 12 is woven about the inner tube 11. Alternately, the tube 11 can be extruded. One or more continuous multifilament fibers are fed from multifilament fiber rolls 53 to the reinforcing weaving station 54 for fabrication of the reinforcing layer 12. The reinforced inner tube 11 then enters a tie layer extruder 56 from which the tie layer 20 is extruded over the reinforcing layer 12. A tie layer hopper 55 delivers tie layer material continuously to the tie layer extruder 56. The hose then enters an abrasion-resistant net weaving station 58 at which the abrasion-resistant layer 14 is woven about the hose over the tie layer 20. One or more monofilament strands 18 are continuously supplied to the abrasion-resistant net weaving station 58 from monofilament supply rolls 57 for fabrication of the abrasion-resistant layer 14. The hose then enters a cross-head extruder 60 which extrudes the cover layer 16 over the abrasion-resistant layer 14. The material utilized in the cover layer 16 is continuously supplied to the cover extrusion station 60 from a cover material supply hopper 59. The finished hose 10 is then stored on a hose take-up roll 62.

If a low-pressure hose 30 is fabricated, the fabrication proceeds as described above, except that a reinforcing layer 12 is not provided, and the reinforcing weaving station 54 and the reinforcing multifilament rolls 53 are not utilized. If the tie layer 20 is not applied, the tie layer extruder 56 and the tie layer hopper 55 are not utilized.

The reinforcing layer 12 is included when the hose 10 will be used to carry fluids under high-pressure, typically a working pressure of 1000-5000 psi. It can be eliminated in hoses used in low-pressure applications, typically working pressures of 500 psi and less.

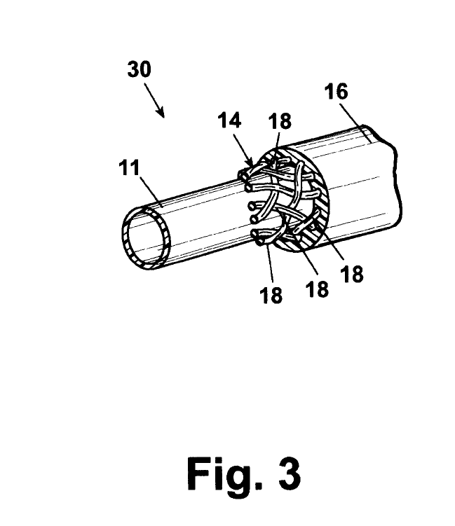

A second embodiment according to the invention comprising a low-pressure hose 30 is shown in FIG. 3 where like numbers are used to indicate like elements. The hose 30 comprises an inner tube 11, a cover layer 16, and an abrasion-resistant layer 14 identical to the inner tube 11, the cover layer 16, and the abrasion-resistant layer 14 of the high-pressure hose 10. As with the hose 10, a tie layer 20 can optionally be provided between the reinforcing layer 12 and the abrasion-resistant layer 14 to ensure adequate bonding of the polypropylene and nylon layers.

The function of the monofilament layer 14 is to provide enhanced abrasion resistance to the cover layer 16 rather than serve as reinforcement against bursting or collapse. The abrasion resistance is surprisingly good compared to hoses without the woven monofilaments. For example, conventional high pressure hoses without the loose-woven monofilament layer 14 typically fail standard abrasion tests at less than 15,000 cycles in standard abrasion tests whereas the same hose constructions with the woven abrasion-resistant monofilament layer 14 do not fail even after in excess of 250,000 cycles in the same test.

Several tests were performed on hoses comprising the inner tube 11, the reinforcing layer 12, and the outer cover layer 16 with and without the abrasion-resistant layer 14. The hoses with and without the abrasion-resistant layer 14 were fabricated of identical materials for the common layers, i.e. the inner tube, the reinforcing, the cover layer. The hose without the abrasion-resistant layer 14 was tested on a standard abrasion apparatus which abraded the outer cover layer 16 until the reinforcing layer 12 was exposed. The reinforcing layer 12 became exposed after 13,980 test cycles, 20,473 test cycles, 14,150 test cycles, and 10,300 test cycles, for an average of 14,726 test cycles. The hose with the abrasion-resistant layer 14 was tested in the same manner. One test was terminated after 250,000 test cycles and the other was terminated after in excess of 258,000 test cycles, with no exposure of the underlying reinforcing layer at the termination of the tests, thus clearly demonstrating the significant resistance to cover layer abrasion provided by the abrasion-resistant layer 14.

The abrasion-resistant layer enhances the durability and service life of both reinforced and unreinforced hoses due to the high abrasion resistance of the nylon monofilaments. The abrasion-resistant layer protects the reinforcing layer against abrasion and cuts, however minor, which can reduce the effectiveness of the reinforcing layer and render the hose unusable. The enhanced service life of the abrasion-resistant hose reduces the frequency of replacement of the hose due to even minor damage, and further reduces the costs associated with such replacement and the interruption or “down time” caused by the replacement procedure. Additionally, the durability of the cover layer is improved significantly due to the encapsulation of the monofilaments in the cover layer. This improvement is believed to be due to creation by the monofilament strands of numerous discontinuities in the cover layer, which interrupt the failure mechanisms (i.e. typically tearing and spalling) seen in cover layers without the abrasion-resistant layer. Based upon the results of abrasion tests, the service life of a hose that includes an abrasion-resistant layer according to the invention is expected to be 15-20 times the service life of a prior art hose without the abrasion-resistant layer.

While the invention has been specifically described in connection with certain specific embodiments thereof, it is to be understood that this is by way of illustration and not of limitation. Reasonable variation and modification are possible within the scope of the forgoing description and drawings without departing from the spirit of the invention, which is described in the appended claims.

1. A hose comprising:
an inner tube;
a non-reinforcing, abrasion-resistant layer overlying the inner tube and comprising a loosely-woven net of monofilament strands; and
a cover layer overlying the inner tube and encapsulating the abrasion-resistant layer.

2. The hose of claim 1, wherein the monofilament strand diameter is in the range of 0.20 to 0.80 inches.

3. The hose of claim 2, and further comprising a reinforcing layer interposed between the inner tube and the abrasion-resistant layer.

4. The hose of claim 3, wherein the inner tube is a semi-rigid thermoplastic material.

5. The hose of claim 4, wherein the semi-rigid thermoplastic material is polyethylene.

6. The hose of claim 4, wherein the semi-rigid thermoplastic material is nylon.

7. The hose of claim 3, wherein the inner tube is an elastomeric material.

8. The hose of claim 3, wherein the diameter of the monofilament strands is greater than the spacing between the monofilament strands.

9. The hose of claim 3, wherein the spacing between the monofilament strands ranges from 50-200% of the diameter of the monofilament strands.

10. The hose of claim 2, wherein the inner tube is a semi-rigid thermoplastic material.

11. The hose of claim 10, wherein the semi-rigid thermoplastic material is polyethylene.

12. The hose of claim 10, wherein the semi-rigid thermoplastic material is nylon.

13. The hose of claim 2, wherein the inner tube is an elastomeric material.

14. The hose of claim 2, wherein the diameter of the monofilament strands is greater than the spacing between the monofilament strands.

15. The hose of claim 2, wherein the spacing between the monofilament strands ranges from 50-200% of the diameter of the monofilament strands.

16. The hose of claim 2, and further comprising a tie layer between the inner tube and the abrasion-resistant layer to bond the inner tube to the abrasion-resistant layer.

17. The hose of claim 16, wherein the tie layer is adhesive-grade nylon.

18. The hose of claim 17, wherein the monofilament strands are nylon.

19. The hose of claim 16, wherein the tie layer is adhesive-grade urethane.

20. The hose of claim 19, wherein the monofilament strands are polyurethane.

21. The hose of claim 3, and further comprising a tie layer between the reinforcing layer and the abrasion-resistant layer to bond the reinforcing layer to the abrasion-resistant layer.

22. The hose of claim 21, wherein the tie layer is adhesive-grade nylon.

23. The hose of claim 22, wherein the monofilament strands are nylon.

24. The hose of claim 21, wherein the tie layer is adhesive-grade urethane.

25. The hose of claim 24, wherein the monofilament strands are polyurethane.

26. The hose of claim 2, wherein the cover layer is an elastomeric material.

27. The hose of claim 26, wherein the cover layer is selected from the group consisting of polyurethane, a thermoplastic rubber, rubber, and silicone.

28. The hose of claim 1, wherein the spacing between the monofilament strands ranges from 50-200% of the diameter of the monofilament strands.

29. The hose of claim 28, and further comprising a reinforcing layer interposed between the inner tube and the abrasion-resistant layer.

30. The hose of claim 29, wherein the inner tube is a semi-rigid thermoplastic material.

31. The hose of claim 30, wherein the semi-rigid thermoplastic material is polyethylene.

32. The hose of claim 30, wherein the semi-rigid thermoplastic material is nylon.

33. The hose of claim 29, wherein the inner tube is an elastomeric material.

34. The hose of claim 29, wherein the diameter of the monofilament strands is greater than the spacing between the monofilament strands.

35. The hose of claim 28, wherein the inner tube is a semi-rigid thermoplastic material.

36. The hose of claim 35, wherein the semi-rigid thermoplastic material is polyethylene.

37. The hose of claim 35, wherein the semi-rigid thermoplastic material is nylon.

38. The hose of claim 28, wherein the inner tube is an elastomeric material.

39. The hose of claim 28, wherein the diameter of the monofilament strands is greater than the spacing between the monofilament strands.

40. The hose of claim 28, and further comprising a tie layer between the inner tube and the abrasion-resistant layer to bond the inner tube to the abrasion-resistant layer.

41. The hose of claim 40, wherein the tie layer is adhesive-grade nylon.

42. The hose of claim 41, wherein the monofilament strands are nylon.

43. The hose of claim 40, wherein the tie layer is adhesive-grade urethane.

44. The hose of claim 43, wherein the monofilament strands are polyurethane.

45. The hose of claim 29, and further comprising a tie layer between the reinforcing layer and the abrasion-resistant layer to bond the reinforcing layer to the abrasion-resistant layer.

46. The hose of claim 45, wherein the tie layer is adhesive-grade nylon.

47. The hose of claim 46, wherein the monofilament strands are nylon.

48. The hose of claim 45, wherein the tie layer is adhesive-grade urethane.

49. The hose of claim 48, wherein the monofilament strands are polyurethane.

50. The hose of claim 28, wherein the cover layer is an elastomeric material.

51. The hose of claim 50, wherein the cover layer is selected from the group consisting of polyurethane, a thermoplastic rubber, rubber, and silicone.

52. A method of making an abrasion-resistant hose comprising the steps of:
extruding an inner tube;
applying to the outer surface of the inner tube a non-reinforcing, abrasion-resistant, loosely woven net of monofilament strands; and
at least partially encapsulating the woven net of monofilament strands with a cover layer.

53. The method of claim 52, and further comprising the step of interposing a reinforcing layer between the inner tube and the abrasion-resistant layer.

54. The method of claim 53, and further comprising the step of interposing a tie layer between the reinforcing layer and the abrasion-resistant layer to bond the reinforcing layer to the abrasion-resistant layer.

55. The method of claim 54, wherein the tie layer is adhesive-grade nylon.

56. The method of claim 55, wherein the monofilament strands are nylon.

57. The method of claim 54, wherein the tie layer is adhesive-grade urethane.

58. The method of claim 57, wherein the monofilament strands are polyurethane.

59. The method of claim 52, and further comprising the step of interposing a tie layer between the inner tube and the abrasion-resistant layer to bond the inner tube to the abrasion-resistant layer.

60. The method of claim 59, wherein the tie layer is adhesive-grade nylon.

61. The method of claim 60, wherein the monofilament strands are nylon.

62. The method of claim 59, wherein the tie layer is adhesive-grade urethane.

63. The method of claim 62, wherein the monofilament strands are polyurethane.

64. The method of claim 52, wherein the inner tube is a semi-rigid thermoplastic material.

65. The method of claim 64, wherein the semi-rigid thermoplastic material is polyethylene.

66. The method of claim 64, wherein the semi-rigid thermoplastic material is nylon.

67. The method of claim 52, wherein the inner tube is an elastomeric material.

68. The method of claim 52, wherein the diameter of the monofilament strands is greater than the spacing between the monofilament strands.

69. The method of claim 52, wherein the spacing between the monofilament strands ranges from 50-200% of the diameter of the monofilament strands.

70. The method of claim 52, wherein the fiber diameter is in the range of 0.20 to 0.80 inches.

71. The method of claim 52, wherein the cover layer is an elastomeric material.

72. The method of claim 71, wherein the cover layer is selected from the group consisting of polyurethane, a thermoplastic rubber, rubber, and silicone.

73. A hose comprising:
an inner tube formed of a synthetic resin;
a non-reinforcing, abrasion-resistant layer of monofilament strands overlying the inner tube, wherein the monofilament strand diameter is in the range of 0.20 to 0.80 inches; and
a cover layer formed of a synthetic resin overlying the inner tube and encapsulating the abrasion-resistant layer.

74. The hose of claim 73 wherein monofilament strands are arranged in a regular pattern in the abrasion-resistant layer.

75. The hose of claim 74 wherein the spacing between the monofilament strands ranges from 50-200% of the diameter of the monofilament strands.

76. The hose of claim 75 wherein the monofilament strands are nylon.

77. A hose comprising:
an inner tube formed of a synthetic resin;
a non-reinforcing, abrasion-resistant layer of monofilament strands overlying the inner tube, wherein monofilament strands are arranged in a regular pattern in the abrasion-resistant layer and wherein the spacing between the monofilament strands ranges from 50-200% of the diameter of the monofilament strands; and
a cover layer formed of a synthetic resin overlying the inner tube and encapsulating the abrasion-resistant layer.

78. The hose of claim 77 wherein the monofilament strands are nylon.
